(19) United States
(12) Patent Application Publication
(10) Pub. No.: US 2019/0205099 A1
(43) Pub. Date: Jul. 4, 2019

(54) QUANTUM RANDOM NUMBER GENERATOR AND METHOD FOR PRODUCING A RANDOM NUMBER BY MEANS OF A QUANTUM RANDOM NUMBER GENERATOR

(71) Applicant: Robert Bosch GmbH, Stuttgart (DE)

(72) Inventors: Ingo Herrmann, Friolzheim (DE); Oliver Krayl, Gerlingen (DE); Reiner Schnitzer, Reutlingen (DE); Thomas Strohm, Asperg (DE)

(21) Appl. No.: 16/323,474

(22) PCT Filed: Jul. 28, 2017
(86) PCT No.: PCT/EP2017/069185

§ 371 Date: Feb. 5, 2019

(30) Foreign Application Priority Data
Aug. 17, 2016 (DE) 10 2016 215 362.5

(51) Int. Cl. G06F 7/58; G06N 10/00

(52) U.S. Cl. CPC G06F 7/588; G06N 10/00

(57) ABSTRACT

A quantum random number generator is described as having a first single-photon detector that detects a first event, and a second single-photon detector that detects a second event, and as having an electronic circuit by way of which the first single-photon detector and the second single-photon detector are interconnected in such a way that after detection of the first event the latter is outputted and an output of a detected second event is suppressed.

### FIELD OF THE INVENTION

The invention relates to a quantum random number generator and to a method for generating a random number using a quantum random number generator.

### BACKGROUND INFORMATION

Quantum random number generators for use in security systems, having a weak light source and two single-photon detectors, are known. The document “Practical aspects of security certification for commercial quantum technologies” (Walenta et al., DOI: 10.1117/12.2193776), for example, describes a quantum random number generator in which the detectors are activated and a light pulse, which is selected in such a way that on average exactly one photon strikes the detector, is then emitted.

### SUMMARY

By way of a quantum random number generator having a first single-photon detector that detects a first event, and a second single-photon detector that detects a second event, and having an electronic circuit by way of which the first single-photon detector and the second single-photon detector are interconnected in such a way that after detection of the first event the latter is outputted and an output of a detected second event is suppressed, it is advantageously possible also to use actual two-click events as one-click events for generation of a random number. The efficiency of the quantum random number generator can be enhanced by the fact that the number of non-evaluatable measurements is reduced and the bit rate for generating a random number is increased.

A “first event” can be understood here as an event that occurs earlier in time that a second event.

If the electronic circuit of the quantum random number generator is designed to indicate a detection of the first event or of the second event, this has the advantage that a reliable statement can be made as to whether an event has taken place. It is also usefully possible to make a reliable statement as to which of the two single-photon detectors has detected the first event, with the result that either a logical one or a logical zero can be generated.

According to a further aspect, provision can be made that the electronic circuit is embodied to be resettable. Detection of a photon, and thus of an event, can thus occur as often as desired, with the result that a plurality of random numbers can be generated successively in simple fashion.

Usefully, the electronic circuit of the quantum random number generator can have a first bistable trigger element having a first data input, having a first clock input, and having a first reset input, and having a first output and having a first inverted output; and a second bistable trigger element having a second data input, having a second clock input, and having a second reset input, and having a second output and having a second inverted output. This ensures that the quantum random number generator can enable the output of a first event and can efficiently suppress the output of a second event.

In a further embodiment of the invention, it is possible for the electronic circuit to have an OR gate having a first input, having a second input, and having an output. It is thereby possible to make a reliable statement as to whether an event has been detected; and if so, for example, the first output can represent the random bit.

If, in an alternative embodiment of the invention, the first reset input of the first bistable trigger element is connected to the second reset input of the second bistable trigger element, the first bistable trigger element and the second bistable trigger element can then usefully reset the electronic circuit substantially simultaneously.

It is furthermore advantageous if the first single-photon detector is connected to the first clock input of the first bistable trigger element, and the second single-photon detector to the second clock input of the second bistable trigger element. The reason is that this ensures that each of the bistable trigger elements can respectively detect, and output or suppress, only events that derive from the single-photon detector connected to the respective bistable trigger element.

In a further embodiment of the invention, provision can be made that the quantum random number generator has a housing in which the first single-photon detector, the second single-photon detector, and a light source are disposed. This has the advantage that the aforementioned components can be housed in space-saving fashion at the same location.

It is furthermore advantageous if the housing is configured in light-tight fashion, so that light cannot pass from outside into the housing and/or light cannot pass outward out of the housing. The reason is that it is thereby possible to ensure that interfering external light sources cannot influence the single-photon detectors or the electronic circuit, and/or that the light flux or photon flux necessary for a functioning quantum random number generator does not fall below a minimum value.

It is furthermore useful if a housing side facing toward the first single-photon detector and toward the second single-photon detector is embodied in, in particular damped, reflective fashion; and/or that further housing sides are embodied in absorbing fashion. The reason is that it is thereby possible to effectively suppress the optical properties, in particular the proportion of undesired scattered light, from the side walls of the housing. It is furthermore possible to preset, by way of the reflective properties of the housing side facing toward the single-photon detectors, the light flux or photon flux within the housing.

It is furthermore advantageous if the first single-photon detector and the second single-photon detector are configured as single-photon avalanche diodes (SPADs). This is because avalanche diodes or SPADs are inexpensive components that can be mounted in simple fashion on a substrate or a circuit board, in particular in a housing.

The aforementioned advantages also correspondingly apply to a method for generating a random number using a quantum random number generator.

The method can have the steps of: reading in as an event, through a first clock input of a first bistable trigger element, a first signal generated by a photon striking a first single-photon detector; switching through to a first output of the first bistable trigger element a first logical value present at a first data input of the first bistable trigger element; and inverting the first logical value present at the first output, and outputting to a second data input of a second bistable trigger element the first inverted logical value present at a first inverted output of the first bistable trigger element; or reading in as the event, through a second clock input of a second bistable trigger element, a second signal generated by a photon striking a second single-photon detector; switching through to a second output of the second bistable trigger element a second logical value present at a second data input of the second bistable trigger element; and inverting the second logical value present at the second output, and outputting to a first data input of the first bistable trigger element the second inverted logical value present at a second inverted output of the second bistable trigger element.

In a further embodiment of the invention, it is advantageous if a logical one is outputted when a logical one is present as a first logical value at the first output; or if a logical zero is outputted when a logical zero is present as a first logical value at the first output. The reason is that the outputted value can thereby be further processed.

Usefully, a step of conveying the first logical value present at the first output to a first input of an OR gate; and conveying the second logical value present at the second output to a second output of the OR gate; and outputting a resulting logical value to an output of the OR gate in order to indicate that the event has taken place, can be effected. It is thereby possible to ascertain reliably whether an event has taken place. A reliable statement can furthermore be made as to which of the two single-photon detectors detected the first event with which either a logical one or a logical zero can be generated.

It is furthermore advantageous if the first output and the second output are reset after an event has been detected by at least the first single-photon detector or the second single-photon detector. An efficient method can thereby be furnished.

It is furthermore useful if the method is executed repeatedly; if a binary random number is created from a sequence of logical ones and zeroes; and if the random number is generated from the binary random number. The reason is that the random number can thereby be efficiently generated.

### BRIEF DESCRIPTION OF THE DRAWINGS

FIG. 1 schematically depicts an electronic circuit according to the present invention of a quantum random number generator for generating a random number.

FIG. 2 is a side view of a housing cross section of a quantum random number generator according to the present invention.

FIG. 3 is a plan view of a housing cross section of a quantum random number generator according to the present invention.

FIG. 4 shows a method according to the present invention for generating a random number using a quantum random number generator according to the present invention.

### DETAILED DESCRIPTION

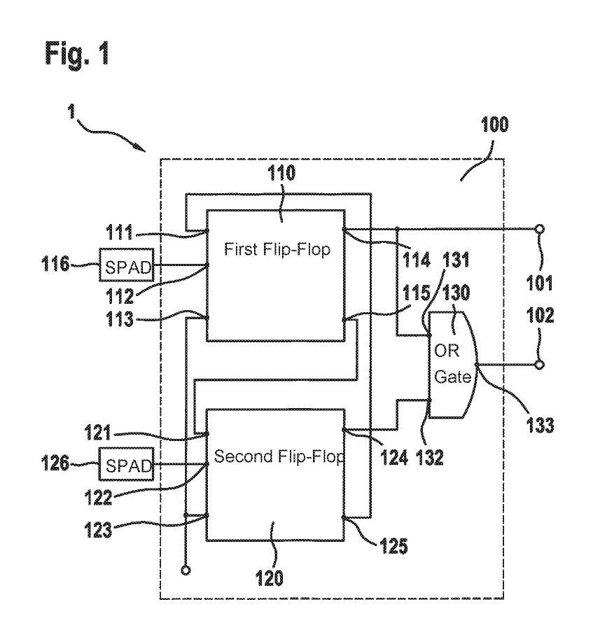

FIG. 1 depicts an electronic circuit 100 according to the present invention, constituting part of a quantum random number generator. Electronic circuit 100 contains a first bistable trigger element 110 as well as a second bistable trigger element 120, which will be referred to hereinafter respectively as first flip-flop 110 and second flip-flop 120. Electronic circuit 100 furthermore contains an OR gate 130.

First flip-flop 110 has a first data input 111 that is connected to a second inverted output 125 of second flip-flop 120. First flip-flop 110 furthermore has a first clock input 112 that is connected to a first photon detector, preferably to a single-photon detector in particular having a single-photon avalanche diode (SPAD 116). First flip-flop 110 furthermore has a first reset input 113, which is connected to a second reset input 123 of second flip-flop 120 and by way of which first flip-flop 110 can be reset. First flip-flop 110 furthermore encompasses a first output 114 as well as a first inverted output 115. First inverted output 115 is connected to second data input 121 of second flip-flop 120. Second flip-flop 120, analogously to first flip-flop 110, has a second clock input 122. A second photon detector, preferably a single-photon detector, in particular a second SPAD 126, can be connected to second clock input 122. Second flip-flop 120 furthermore has second reset input 123, by way of which second flip-flop 120 can be reset simultaneously with first flip-flop 110. Second flip-flop 120 furthermore has a second output 124.

First output 114 of first flip-flop 110 is connected to a first input 131 of OR gate 130. In addition, second output 124 of second flip-flop 120 is connected to second input 132 of OR gate 130. First output 114 of first flip-flop 110 functions here as a first signal output 101 of electronic circuit 100. An output 133 of OR gate 130 functions here as a second signal output 102 of electrical circuit 100.

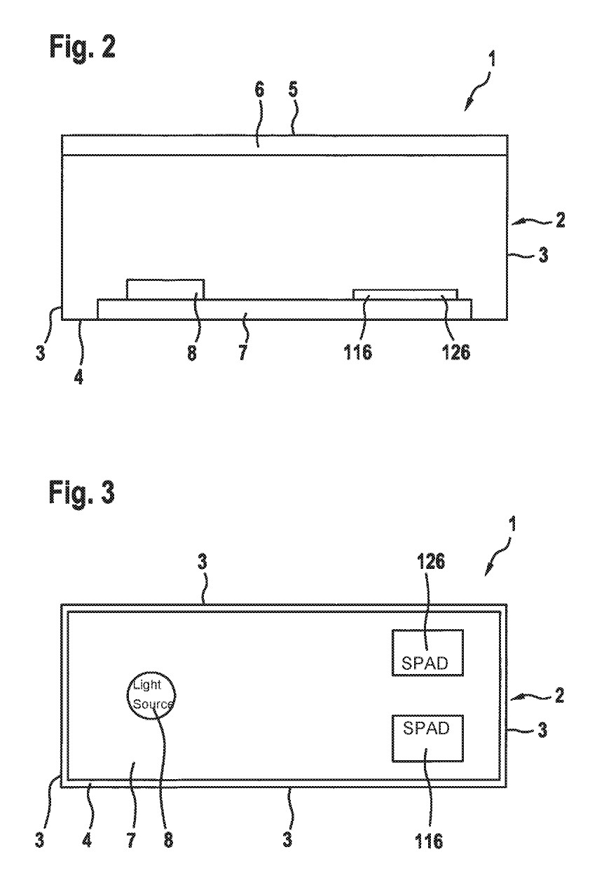

FIG. 2 is a side view of a housing cross section of quantum random number generator 1 according to the present invention. Quantum random number generator 1 has a light-tight housing 2 having side walls 3, a floor 4, and a cover 5. Floor 4, and in particular side walls 3, can usefully be embodied to be light-absorbing. Cover 5 can advantageously be embodied with a reflector 6, such that reflector 6 reflects or attenuates, in damped fashion, light that strikes it. Housing 2 of quantum random number generator 1 furthermore contains a substrate 7 on which are located a light source 8 as well as first SPAD 116 and second SPAD 126.

Light source 8 can be embodied as an incandescent lamp, glow lamp, or halogen lamp, or as a semiconductor light source. In particular, light source 8 can be configured as an LED or laser diode. Light source 8 can furthermore be operated continuously, since according to the present invention a measurement time limitation is the responsibility not of the light source or of an electronic controller of the light source, but of electronic circuit 100 of quantum random number generator 1.

In a further embodiment of the invention it is possible for light source 8 to be configured as a single-photon source. It is useful in this context if the damping of the reflection of the housing wall that is located oppositely from the sources and from the detectors is minimized.

It is useful if light source 8 is embodied to emit short and/or weak light pulses. It is furthermore advantageous if light source 8 is embodied so that the light flux emitted by it is adjustable over a wide range.

Alternatively or additionally, it is possible for the light flux of light source 8 to be limited by a partial shading means or by a shutter.

The light emitted from light source 8 is for the most part reflected in damped fashion at reflector 6, and strikes first SPAD 116 and/or second SPAD 126. That portion of the light which is emitted from light source 8, and strikes side walls 3, is for the most part absorbed by side walls 3. If a photon then strikes first SPAD 116 or second SPAD 126, and if first SPAD 116 and second SPAD 126 are activated, first SPAD 116 or second SPAD 126 then triggers an event.

That event is conveyed to electronic circuit 100, the electrical connections not being shown in FIG. 2.

FIG. 3 is a plan view of a housing cross section of quantum random number generator 1 according to the present invention. Housing 2 encompasses floor 4 as well as side walls 3, which are embodied to be absorbent. Substrate 7 is attached to or mounted on floor 4. Light source 8, as well as first SPAD 116 and second SPAD 126, is attached to or mounted on substrate 7. First SPAD 116 and second SPAD 126 can be distributed symmetrically around light source 8. It is also possible for light source 8 and/or first SPAD 116 and/or second SPAD 126 to be located on separate substrates.

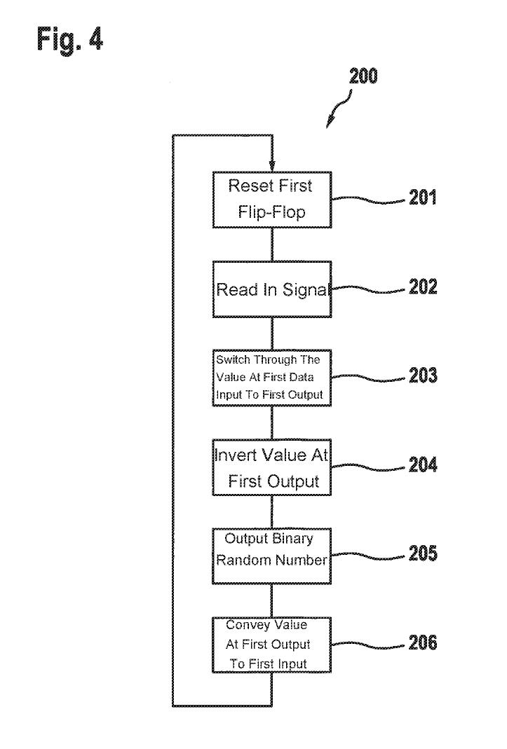

FIG. 4 depicts a method 200 according to the present invention for generating a random number using quantum random number generator 1 according to the present invention. If first flip-flop 110 and second flip-flop 120 are not reset, a first step 201 of resetting first flip-flop 110 and second flip-flop 120 via first reset input 113 and second reset input 123 can occur. The result is that a zero is present respectively at first output 114 and at second output 124. The zero present at first output 114 is conveyed both to first signal output 101 and to first input 131 of OR gate 130. The zero present at second output 124 is conveyed to second input 132 of OR gate 130. A zero is thus also present at output 133 of OR gate 130 and is conveyed to second signal output 102.

Because a zero is present both at first output 114 and at second output 124, a one is present at inverted outputs 115, 126 of first flip-flop 110 and of second flip-flop 120. Because first inverted output 115 is connected to second data input 121, and second inverted output 125 to first data input 111, a one is also present at first data input 111 and at second data input 121.

In a second step 202, reading in of a signal generated by a photon striking first SPAD 116, constituting an event, can be effected through first clock input 112 of first flip-flop 110. This event, or this clock pulse present at first clock input 112, causes the one present at first data input 111 to be switched through in a third step 203 to first output 114. A one is therefore likewise present at first output 114.

Substantially simultaneously in a fourth step 204, an inversion of the value present at first output 114 to a zero occurs, that zero being outputted at first inverted output 115 to second data input 121. A zero is then also present at second data input 121. If a further photon then strikes second SPAD 126, the signal generated by the photon striking second SPAD 126 is then conveyed as an event or clock pulse to second clock input 122. But because second data input 121 is at zero, that zero is switched through to second output 124 of second flip-flop 120.

Because in this case a photon has struck first SPAD 116 after the resetting or activation of electrical circuit 100, a one is now present at first output 114 and a zero at second output 124. This corresponds to a first binary random number that, in a fifth (outputting) step 205, can be outputted to an evaluation unit that is not shown. Any quantity of binary random numbers, and thus in general a random number, can be generated by multiple repetition of steps 201, 202, 203, 204, 205.

Optionally, in a sixth step 206 the one present at the first output can be conveyed to first input 131, and the zero present at second output 124 can be conveyed to second input 132, of OR gate 130. The result is that a one is present at output 133 of OR gate 130 and is outputted at second signal output 102. The combining of the two values in OR gate 130 ensures that an event that is triggered by a photon striking first SPAD 116 or second SPAD 126 is in fact registered as such.

This is advantageous in particular if not first SPAD 116 but instead second SPAD 126 registers a photon. In this case the event that is registered is conveyed as a clock signal to second clock input 122, with the result that the one present at second data input 212 is switched through to second output 124. The zero now present at second inverted output 125 is conveyed substantially simultaneously to first data input 111 of first flip-flop 110. Even if a further photon additionally strikes first SPAD 116 within the evaluation times of electronic circuit 100, the clock signal or event arriving at first clock input 112 merely causes the zero present at first data input 111 to be switched through to first output 114. This zero present at first output 114 is then conveyed both to first input 131 of OR gate 130 and to first signal output 101. The one present at second output 124 is conveyed to second input 132 of OR gate 130. The result is that a one is present at output 133 of OR gate 130 and is conveyed to second signal output 102.

The one that is present at second output 102 ensures that an event has taken place. The zero present at the first signal output likewise corresponds to a binary random number from which a random number can be generated by multiple repetition of steps 201, 202, 203, 204, 205, 206.

1.-15. (canceled)

16. A quantum random number generator, comprising:
a first single-photon detector that detects a first event;
a second single-photon detector that detects a second event; and
an electronic circuit by way of which the first single-photon detector and the second single-photon detector are interconnected in such a way that after detection of the first event the detection of the first event is outputted and an output of a detected second event is suppressed.

17. The quantum random number generator as recited in claim 16, wherein the electronic circuit indicates a detection of the first event or of the second event.

18. The quantum random number generator as recited in claim 16, wherein the electronic circuit is resettable.

19. The quantum random number generator as recited in claim 16, wherein the electronic circuit includes:
a first bistable trigger element that includes:
a first data input,
a first clock input,
a first reset input,
a first output, and
a first inverted output; and
a second bistable trigger element that includes:
a second data input,
a second clock input,
a second reset input,
a second output, and
a second inverted output.

20. The quantum random number generator as recited in claim 19, wherein the electronic circuit includes an OR gate that includes a first input, a second input, and an output.

21. The quantum random number generator as recited in claim 19, wherein the first reset input of the first bistable trigger element is connected to the second reset input of the second bistable trigger element.

22. The quantum random number generator as recited in claim 19, wherein:
the first single-photon detector is connected to the first clock input of the first bistable trigger element, and
the second single-photon detector is connected to the second clock input of the second bistable trigger element.

23. The quantum random number generator as recited in claim 16, further comprising:
a light source; and
a housing in which the first single-photon detector, the second single-photon detector, and the light source are disposed.

24. The quantum random number generator as recited in claim 23, wherein the housing is light-tight.

25. The quantum random number generator as recited in claim 23, wherein at least one of:
a housing side facing toward the first single-photon detector and toward the second single-photon detector is reflective, and
further housing sides are absorbing.

26. The quantum random number generator as recited in claim 25, wherein the housing side facing toward the first single-photon detector and toward the second single-photon detector is damped.

27. The quantum random number generator as recited in claim 16, wherein each one of the first single-photon detector and the second single-photon detector is configured as a single-photon avalanche diode.

28. The quantum random number generator as recited in claim 27, wherein the single-photon avalanche diode includes a SPAD.

29. A method for generating a random number using a quantum random number generator that includes a first single-photon detector that detects a first event, a second single-photon detector that detects a second event, and an electronic circuit by way of which the first single-photon detector and the second single-photon detector are interconnected in such a way that after detection of the first event the detection of the first event is outputted and an output of a detected second event is suppressed, the method comprising:
performing one of a first process and a second process, the first process including:
reading in as an event, through a first clock input of a first bistable trigger element, a first signal generated by a photon striking the first single-photon detector;
switching through to a first output of the first bistable trigger element a first logical value present at a first data input of the first bistable trigger element; and
inverting the first logical value present at the first output; and
outputting to a second data input of a second bistable trigger element the first inverted logical value present at a first inverted output of the first bistable trigger element; and the second process including:
reading in as the event, through a second clock input of a second bistable trigger element, a second signal generated by a photon striking the second single-photon detector;
switching through to a second output of the second bistable trigger element a second logical value present at a second data input of the second bistable trigger element;
inverting the second logical value present at the second output; and
outputting to a first data input of the first bistable trigger element the second inverted logical value present at a second inverted output of the second bistable trigger element.

30. The method as recited in claim 29, further comprising one of:
outputting a logical one when a logical one is present as a first logical value at the first output; and
outputting a logical zero when a logical zero is present as a first logical value at the first output.

31. The method as recited in claim 29, further comprising:
conveying the first logical value present at the first output to a first input of an OR gate;
conveying the second logical value present at the second output to a second output of the OR gate; and
outputting a resulting logical value to an output of the OR gate in order to indicate that the event has taken place.

32. The method as recited in claim 29, further comprising resetting the first output and the second output.

33. The method as recited in claim 29, wherein the method is executed repeatedly, a binary random number being created from a sequence of logical ones and zeroes, and the random number being converted from the binary random number.
